(19) United States
(12) Patent Application Publication
(10) Pub. No.: US 2019/0294534 A1
(43) Pub. Date: Sep. 26, 2019

(54) PROGRAM USABILITY PERFORMANCE CLASSIFICATION

(71) Applicant: CA, Inc., New York, NY (US)

(72) Inventors: Thomas Patrick Kennedy, East Northport, NY (US); Steven L. Greenspan, Scotch Plains, NJ (US); Sunny Vinu Mistry, Ronkonkoma, NY (US)

(21) Appl. No.: 15/933,256

(22) Filed: Mar. 22, 2018

(51) Int. Cl. G06F 11/36; G06F 11/34; G06F 11/30

(52) U.S. Cl. CPC G06F 11/3688; G06F 11/302; G06F 11/3409; G06F 11/3676

(57) ABSTRACT

Methods, systems, and program products are disclosed for generating performance classifications for program elements. Program elements of a program are associated with reference elements of a reference document that describes the program. A first set of user interface inputs to the reference document are recorded including recording each of the first set of interaction based events in association with a respective one or more of the reference elements. A performance classifier is executed to generate a performance classification for one or more of the program elements based on one or more patterns formed, at least in part, by the first set of interaction based events.

### BACKGROUND

The disclosure generally relates to the field of data processing, and more particularly to determining aspects of program performance.

Product management solutions address requirements of developers and information technology (IT) managers to collect and analyze performance information for program products. Controlled testing used during development phases provides information regarding fundamental product operation and performance. However, expanding numbers and varieties of applications and host platform environments, such as mobile device processing environments, require more comprehensive and flexible performance monitoring solutions and architectures. To address the foregoing issues, program monitoring solutions may employ components for directly collecting application performance data and processing results that are displayed using views that aid developers and IT managers in efficiently determining and understanding operating conditions and trends for various aspect of the application(s) being monitored.

In addition to directly measured program performance information, user feedback information is frequently utilized to facilitate program code product development and support by providing insight into user-centric, qualitative aspects of program performance. User feedback information is particularly important in evaluating performance of a program. However, methods and system for obtaining precise and accurate user feedback are typically costly and sometimes are insufficiently flexible for effective deployment in program development and modification cycles that are increasingly incremental and continuous between major product version releases.

### BRIEF DESCRIPTION OF THE DRAWINGS

Embodiments of the disclosure may be better understood by referencing the accompanying drawings.

FIG. 1 is a block diagram depicting hardware and software systems, devices, and components within a program performance testing system implemented in an application server environment in accordance with some embodiments;

FIG. 2A is a block diagram illustrating subsystems, devices, and components within a system for collecting and processing document activity metrics to generate performance classifier plugins in accordance with some embodiments;

FIG. 2B depicts document activity records, program operation records, association records, and classification records that are generated, combined, and otherwise processed to generate training records in accordance with some embodiments;

FIG. 2C illustrates training records processed by a classification trainer to generate a performance classification plugin in accordance with some embodiments;

FIG. 2D depicts a conceptual representation of a k-NN map generated by a performance classifier in accordance with some embodiments;

FIG. 3 is a flow diagram illustrating operations and functions for configuring a performance classifier in accordance with some embodiments;

FIG. 4 is a flow diagram depicting operations and functions performed as part of program performance classification in accordance with some embodiments; and

FIG. 5 is a block diagram depicting an example computer system that may be utilized to classify program performance based on reference document interaction in accordance with some embodiments.

### DESCRIPTION

The description that follows includes example systems, methods, techniques, and program flows that embody embodiments of the disclosure. However, it is understood that this disclosure may be practiced without some of these specific details. In other instances, well-known instruction instances, protocols, structures and techniques have not been shown in detail in order not to obfuscate the description.

Overview

Disclosed embodiments includes methods, devices, and systems that utilize reference document user interface (UI) activity, also referred to as interaction events detected by a UI, to identify or otherwise determine performance issues relating to user experience during operation of a program. As utilized herein a “program” or “program product” refers to one or more sets of individually or collectively compiled instructions that are executable by a computer. For example, a program may refer to multiple programs that are statically linked and therefore collectively compiled and executed. A program may also or alternatively refer to multiple programs one or more of which are dynamically linked and therefore independently compiled and called or otherwise linked during execution. The program may be an application program under test such as a database application that includes components and multi-component features that may be individually assessed such as by users during performance testing cycles. A reference document that describes the program is an electronic document such as an operation manual. The reference document is formatted in accordance with an underlying electronic document format to include multiple sub-sections, referred to alternately as document elements, reference element or elements, of the document.

The components and multi-component features of the program, referred to alternately as program elements, are pre-selected to be indexed or otherwise associated with a set of the reference elements. The indexing may include recording associations between program elements and reference elements based on a quantitative and/or qualitative analysis of the descriptive correlation between the reference elements and corresponding program elements. The indexing is performed by a performance classification system that further comprises components that leverage the indexing information during classifier training and classification operations to more precisely, accurately, and efficiently determine performance classifications for programs. Such components may include a training data generator that collects quantitative results in the form of accumulated interaction based event metrics associated with contemporaneous or otherwise operationally associated program element operation metrics.

The training data generator further collects qualitative results in the form of user-specified program element performance classifications that may be used as supervisor values when associated with the combinations of operational metrics and interaction based event metrics. A pattern recognition trainer component processes one or more training-cycle-specific sets of quantitative and qualitative training data to configure pattern recognition code for a performance classifier. The performance classifier may be a program extension, such as a plugin, called by a performance test system to determine performance classifications of one or more program elements of a program based, at least in part, on patterns of reference element interaction based events.

Example Illustrations

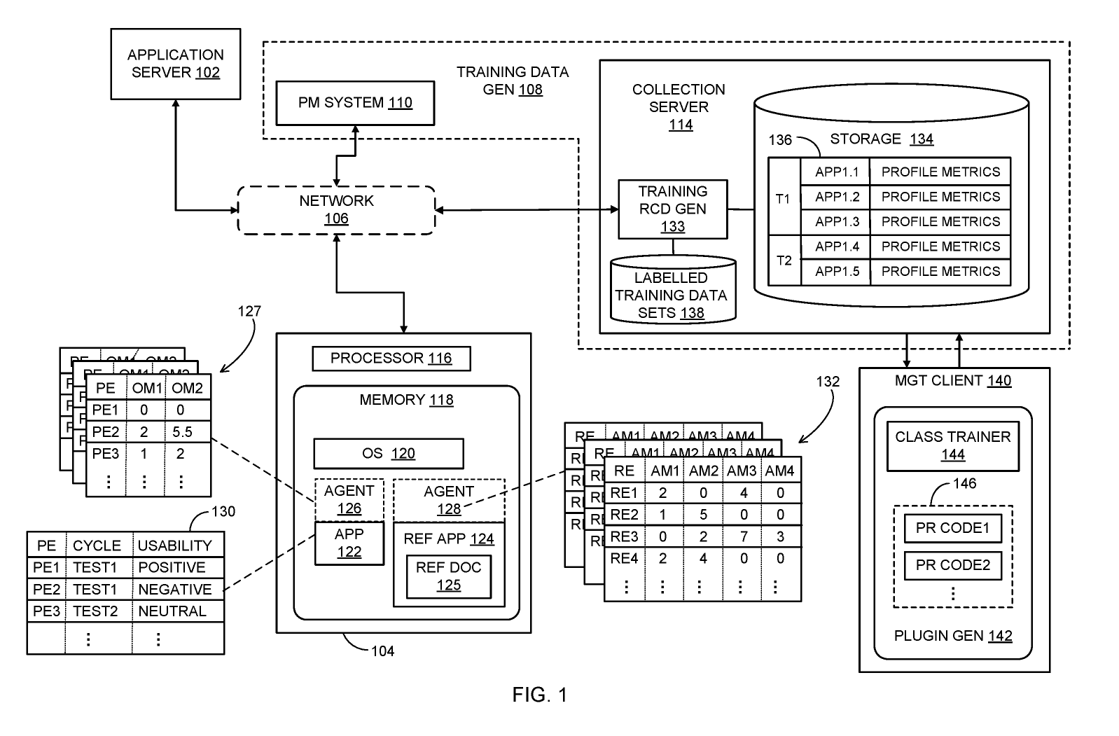

FIG. 1 is a block diagram depicting hardware and software systems, devices, and components within or used by a program testing system implemented in an application server environment in accordance with some embodiments. The systems include a network 106 that provides connectivity over which a client device 104 communicates with an application server 102 that provisions application program instances to clients such as client device 104. The connectivity may be established by multiple subnetworks and different types of network components, connection media and protocols, and carrier services such as fiber optic cables, telephone lines, Ethernet 802, and Internet protocols. In one aspect, network 106 enables communications between client device 104 and application server 102 to enable client device 104 to request and obtain software downloads from application server 102.

Client device 104 may be a compact and mobile computing/networking device or a highly integrated computer platform such as a personal computer. In addition to a network interface, client device 104 includes a main processor 116 and an associated system memory 118 that stores data and system and application software including an application program 122 and a reference document application program 124. In combination, processor 116 and memory 118 provide information processing capability necessary for network communications and furthermore to enable client device 104 to perform other information handling tasks related to, incidental to, or unrelated to the methods described herein. An operating system (OS) 120 executed from system memory 118 may be a flexible, multi-purpose OS and may generally comprise code for managing and providing services to hardware and software components within client device 104 to enable program execution and input/output functions.

Program 122 may be any of a variety of application program types such as a database, a system management application, a code development application, etc. Reference application 124 is a program for generating, storing, rendering and otherwise processing an electronic reference document 125, which is generated, stored, and accessed as a distinct file. For example, reference application 124 may be a document rendering program that implements a version of the portable document format (PDF) file format. Reference document 125 is an electronic document file comprising text and images that depict and describe the features and operation of program 122. Reference document 125 includes various distinctly identifiable sections, referred to alternately as reference elements, which are individually identifiable in accordance with the document format. During operation/execution of program 122, user interface inputs may be received by reference application 124 to display reference document 125 which may, for example, be referenced by a user input via a UI to facilitate interactive operation of program 122.

Processor 116 and main memory 118 provide a storage and execution platform for operation/activity information collection code that may be part of or supplementary to the program code of application programs 122 and 124. The collection code includes an application agent 126 and a reference document agent 128. Application agent 126 is configured using any combination of program code to collect operation metrics associated with the execution of program 122. The particular types/categories of operation metrics collected by application agent 126 are determined in accordance with a collection profile received by application agent 126 from a management system such as a performance monitor system 110. For example, performance monitor system 110 may generate a collection profile message that specifies multiple program components/elements, such as a particular UI, for and/or from which operation metrics are to be collected. Application agent 126 comprises program instructions for detecting operational conditions and events as categories of operation data that may be recorded as events or quantified in terms of specified operational metrics values.

As shown, application agent 126 generates multiple program operation records 127, each corresponding to a respective training or test cycle. During a training or a test cycle, application agent 126 collects a set of operation metrics for each of multiple program elements within program 122. The set of operation metrics (i.e., combination of particular types of metrics) and the program elements are determined based on a collection profile that may be individually specified and modified for each training or test cycle. As depicted, program operation records each comprise multiple row-wise program element records corresponding to program elements PE1, PE2, PE3, etc. Each program element record associates a program element ID code (e.g., “PE2”) with a combination of operation metrics (e.g., OM=2, OM2=5.5).

Application agent 126 further comprises program code that interacts with UI code of program 122 during a training cycle to generate program element classification records including a program element classification record 130. As part of a training cycle, which may coincide with a test cycle, the UI program components of program 122 generates a UI object to which inputs corresponding to program element classifications are received and detected by application agent 126. For example, the UI object may include multiple input selection objects such as menu selection boxes each corresponding to a respective displayed program element ID. A user enters classifiers such a text-based menu selections, POSITIVE, NEGATIVE, NEUTRAL into the input selection objects and the results are recorded such as within program element classification record 130. Application agent 126 generates classification record 130 to include multiple row-wise program element records that associate a program element ID code (e.g., “PE3”) with a training cycle ID (e.g., “TEST2”), and a performance classification (e.g., “NEUTRAL”).

In response to detecting or otherwise collecting the operation metrics and program element classifications, application agent 126 sends the resultant records via network 106 to a training data generator 108 that includes, in part, performance monitor system 110. Training data generator 108 further includes a collection server 114 that is configured, using any combination of hardware and software components, to collect and organize data for each of the program elements based on the collection profiles specified by performance monitor system 110. Applicant agent 126 is configured to send program operation records such as program operation records 127 and classification records such as classification record 130 to training data generator 108 and particularly to collection server 114.

To communicate the training and/or test data to collection server 114, client device 104 may operate as an initiator device, initiating an update transaction with an update request. Alternatively, collection server 114 may request the training and/or test data updates via a centralized hub (not depicted) to which client device 104 is a subscriber. In either case, collection server 114 includes a training record generator 133 that processes the received updates from monitoring agents such as monitoring agents 126 and 128, and stores the data within a storage system 134. In the depicted embodiment, the data stored within storage system 134 is logically organized at a file system or higher level by a database 136. Database 136 may be a relational database, such as an SQL database, or may be an object-based database such as a Cassandra database. In the depicted embodiment, training record generator 133 stores records that associate data with respective application IDs, such as IDs of applications 122 and 124, from which the data was collected via agents 126 and 128. To further support logically structured and secure access to the records within database 136, training record generator 133 is further configured to collect and record additional client-related information from clients such as client 104. For example the records within database are associated starting with tenant keys T1 and T2, each of which are associated with a number of application records APP1.1-APP1.5, respectively.

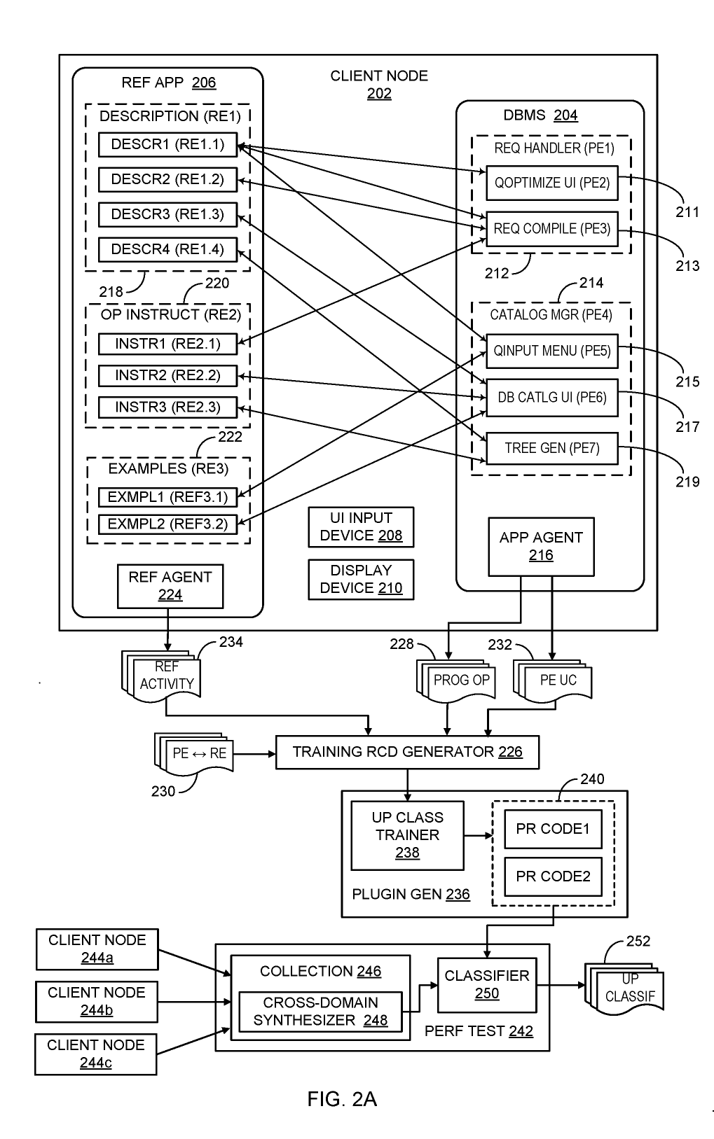

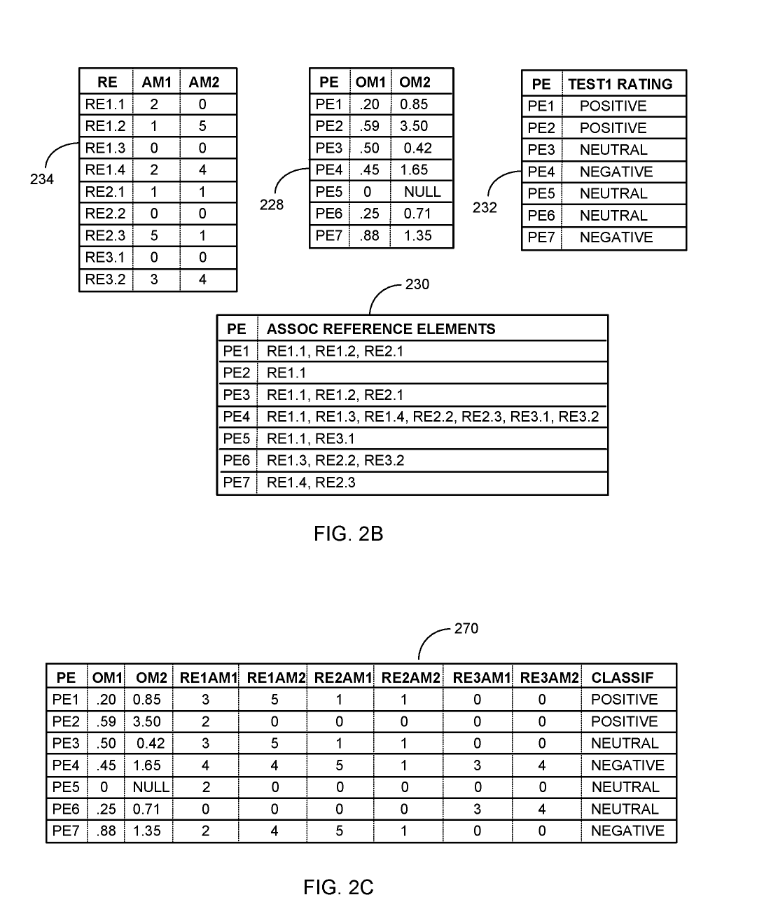

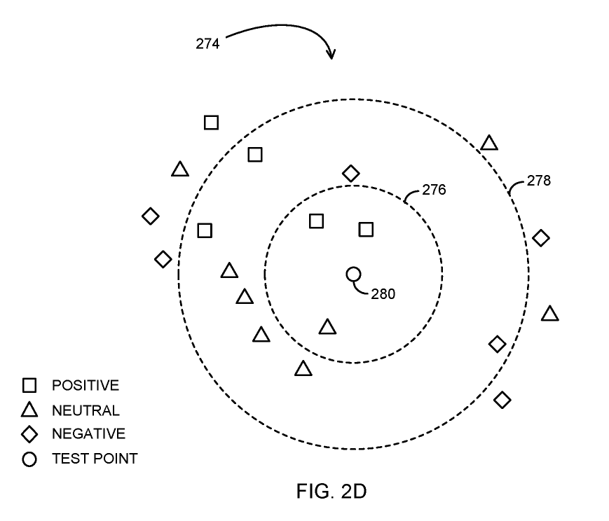

Training record generator 133 is further configured to generate labelled training data sets 138 from the program and application reference information stored within database 136. More specifically, training record generator 133 processes program operation records 127, document activity records 132, and program element classification records 130 received from client device 104 to generate training records having supervisor values in the form of performance classifiers. As depicted and described in further detail with reference to FIGS. 2A and 2C, training data sets 138 comprise multiple training records each corresponding to a respective training/test cycle. Each record associates the program element ID with a combination of reference element activity metrics collected by agent 128 for reference elements corresponding to the program element during a training cycle. Each of the training records may further associate the program element ID with a combination of operation metrics collected for the program element corresponding to the program element ID. In some embodiments, the combinations of operation metrics and reference element activity metrics (also referred to as document activity metrics) form an input vector pattern combination that can be used for pattern recognition and/or pattern matching functions. Each of the records within training data sets 138 further includes a classifier entry that may be used as a supervisor value during pattern recognition training.

The training records within training data sets 138 are provided to a management client 140 to generate usability performance classification modules. Management client 140 includes a plugin generator 142 that receives and processes training records generated by training data generator 108 to generate performance classification plugins that include patterns recognition code. As depicted and described in further detail with reference to FIGS. 2A-2D, plugin generator 142 includes a classification training component, classification trainer 144, configured to execute a supervised learning function on the labelled training data. Classification trainer 144 processes the labelled input vector patterns and associated supervisor classifier values for each of the training records to generate usability pattern recognition code for a given set of the training records. Plugin generator 142 stores the resultant plugins 146 including pattern recognition code PR CODE1 and PR CODE 2 to be called and executed during performance test operations to classify the usability performance of program elements based on associated combinations of reference element activity metrics and program element operational metrics.

FIG. 2A is a block diagram illustrating subsystems, devices, and components within a system for collecting and processing document activity metrics to generate performance classifier plugins in accordance with some embodiments. The subsystems, devices, and components depicted and described with reference to FIGS. 2A-2D may be implemented by and/or incorporated in the system depicted in FIG. 1. As shown in FIG. 2A, the system includes a client node 202 that provides a processing and storage platform for an application program in the form of a database management system (DBMS) 204. Client node 202 also stores and provides an execution platform for a reference application 206 that is configured to render and otherwise process a reference document that describes DBMS 204.

DBMS 204 includes several program elements including a request handler 212 (PE1) and a catalog manager 214 (PE4). Request handler 212 comprises any combination of program code and data for processing query requests from a database client to retrieve requested portions of database data content. In support of these functions, request handler 212 includes a query optimization UI 211 (PE2) and a request compiler 213 (PE3). Catalog manager 214 comprises any combination of program code and data for generating and modifying the database catalog that stores database schema object definitions. In support of these functions, catalog manager 214 includes a query input menu 215 (PE5), a database catalog UI 217 (PE6), and an object tree generator 219 (PE7).

Incorporated or otherwise communicatively associated with DBMS 204 is an application agent 216 that, similar to agent 126 in FIG. 1, is configured to collect sets of operation metrics for one or more of the program elements PE1-PE7 during execution of DBMS 204. The particular program elements for which operation metrics are collected and the particular types of operation metrics to be collected may be determined in accordance with a collection profile generated external to DBMS 204. The operation metrics may be recorded and output from application agent 216 as program operation records including a program operation record 228. FIG. 2B illustrated the details of program operation record 228, which is generated by application agent 216 and received and processed by a training record generator 226.

As shown in FIG. 2B, program operation record 228 includes multiple row-wise program element records that each associate a program element ID with a set of two operation values corresponding to a combination operation metric types, OM1 and 0M2. The operation metric types may be, for example, activity levels, execution time, load time, etc. OM1 may be activity level as a percentage for the program element over an operation cycle, and 0M2 may be an information throughput ratio for the program element over the same operation cycle. The OM1 field in each record specifies a percent of the operation cycle period that the corresponding program element is active (e.g., loading and executing). The 0M2 field in each record specifies the ratio of information throughput during the operation cycle to an average throughput value for the respective program element.

Applicant agent 216 is further configured to generate performance classification records for the program elements such as performance classification record 232. As shown in FIG. 2B, performance classification record 232 comprises multiple row-wise records each associating a program element ID with one of three usability performance classifier codes, POSITIVE, NEGATIVE, and NEUTRAL. In some embodiments, the records within classification record 232 are collected during and associated with a specified test operation cycle, TEST1, over which the operation metrics within program operation record 228 were detected and recorded.

Also during test operation cycle, TEST1, a reference agent 224 within or otherwise communicatively coupled with reference application 206 detects and records interaction based events associated with the reference document comprising RE1 218, RE2 220, and RE3 222. For example, reference agent 224 detects interaction based events such as page and object selections in association with the reference elements to generate a document activity record 234 during TEST1. As shown in FIG. 2B, document activity record 234 comprises multiple row-wise records that each associate a reference element ID with activity metric values corresponding to a combination of activity metric types, AM1 and AM2. AM1 may represent a displayed pointer hover activity such as may be defined as occurring with a displayed pointer is detected to hover over a displayed portion of a reference element for a threshold period. AM2 may represent a UI select input activity such as a UI pointer device or keyboard selection of an object comprising or within a reference element. In the foregoing manner, the values for AM1 and AM2 are integer count values. For instance, the fourth row-wise record of document activity record 234 associates RE1.4 with a count of two hovers and four selections of RE1.4 over the TEST1 test operation cycle.

Test information collected over TEST1, including program operation record 228, classification records 232, and document activity record 234 are received and processed by training record generator 226 in conjunction with index record 230 to generate cross-domain training records. Index record 230 may be generated by training record generator 226 or external to training record generator such as by application agent 216. As depicted in FIG. 2B, index record 230 associates each of the program elements with reference elements of a reference document rendered by reference application 206. The reference document may be a user reference document that depicts and describes various aspects of DBMS 204. In FIG. 2A, the reference elements include a description section 218 (also labelled RE1), an operation instruction section 220 (also labelled RE2), and an examples section 222 (also labelled RE3). The reference elements further include sub-elements of reference elements RE1 218, RE2 220, and RE3 222. RE1 218 comprises description sub-sections RE1.1, RE1.2, RE1.3, and RE1.4. RE2 220 comprises operation instruction sub-sections RE2.1, RE2.2, and RE2.3, and RE3 222 comprises examples sub-sections RE3.1 and RE3.2. As depicted in FIG. 2B, index record 230 comprises multiple row-wise records that each associate a program element ID with a respective set of reference element IDs. For example, the third row-wise record associates program element PE3 with reference elements RE1.1, RE1.2, and RE2.1.

FIG. 2C depicts an example training record 270 comprising the program element and reference element information collected over TEST1. Training record 270 comprises multiple row-wise records each associating a program element ID with the operation metrics recorded for the corresponding program element over TEST1. For example, the fourth row-wise record associates program element PE4 (catalog manager 214) with an OM1 value (percent of TEST1 period that PE4 is active) of 0.45. The record further associates PE4 and the OM1 value with an OM2 value (ratio of information throughput during TEST1 to an average throughput value for PE4) of 1.65.

Training record 270 is “cross-domain” because it combines program element operation information patterns (i.e., combinations of multiple different types of operation metrics) with reference element input activity patterns. Each row-wise records further associates the program element ID and a combination of program element operation metrics with a combination of UI activity metrics associated with reference elements that are associated with the program elements. The reference element UI activity information is collected from document activity record 234 in combination with association record 230. For example, the fourth row-wise record of training record 270 associates PE2 with the corresponding metrics 0.45 and 1.65 and also with six activity metric fields RE1AM1, RE1AM2, RE2AM1, RE2AM2, RE3AM1, RE3AM2.

As indicated by the field labels, the activity metric fields record values corresponding to one of the metric types (AM1 or AM2) and also corresponding to the reference elements associated with the program element ID. For instance, the value in each of the metric fields for the fourth row-wise record corresponds to the cumulative total for the reference elements RE1.1, RE1.3, RE1.4, RE2.2, RE2.3, RE3.1, and RE3.2 associated by association table 230 with PE4. Training record generator 226 further associates each record, by inclusion within a record field or otherwise, a respective usability performance classification based on the performance classifiers recorded in classification records 232 during TEST1. The resulting row-wise program element records within cross-domain training record 270 provide multiple supervised training inputs including a multivariate vector comprising the reference element activity metric fields and the program element operation metric fields with the classifier serving as the supervising value for each record.

With reference to FIG. 2A, the training records such as cross-domain training record 270 generated by training record generator 226 are received and processed by a plugin generator 236. Plugin generator 236 is configured, using any combination of program logic and data, to process training records to generate classification extension/plugin code that can be used to classify usability performance of program elements during runtime test operations. Plugin generator 236 includes a usability performance classification trainer 238 that receives a series of training records such as training record 270 as supervised training data input and processes the records to generate classification plugins 240 that each include respectively configured pattern recognition code. Plugins 240 are individually depicted as pattern recognition code1 and pattern recognition code2 (PR CODE1 and PR CODE2). Classification trainer 238 processes the classifier-supervised training records generated by training record generator 226 to generate usability performance classification plugins 240 that include patterns recognition code. Classification trainer 238 is configured to execute a supervised learning function on the labelled training data (e.g., each metric component of the multivariate vector is labeled such as by activity metric or operation metric type) to generate the pattern recognition code.

The system depicted in FIG. 2A further includes a performance test system 242 that accesses plugins 240 during or following test or non-test operation cycles of programs to generate usability performance classifications of program elements. Performance test system 242 comprises a collection unit 246 that is configured using program code to collect operation metrics and interaction based event activity metrics such as those recorded in program operation record 228 and document activity record 234. Collection unit 246 may further retrieve indexing/association information that associates program elements of a program with reference elements of a reference document. The operation metrics, reference element activity metrics, and association information may be retrieved from one or more of the client node 202 used for training and/or other client nodes 244a-244c that are configured to include similar program, program element, program agent, reference application, reference agent, and reference document components. Collection unit 246 includes a cross-domain synthesizer 248 comprising program code configured similarly to generate cross-domain records that are constructed similarly to training record 270 except with no classifiers having been collected and recorded.

The cross-domain records generated by cross-domain synthesizer 248 are received and processed by a performance classifier 250 that comprises, at least in part, one or more of the performance classification plugins 240 called or otherwise retrieved from plugin generator 236. When executed, performance classifier 250 generates a multidimensional feature space that was determined by classification trainer 238 during the training phase. A conceptual representation of an example k-NN map feature space is illustrated in FIG. 2D. As shown in FIG. 2D, the feature space 274 is populated with multiple training value points each having a respective assigned performance classification. The depicted squares are points in the feature space each classified by classification trainer 238 as POSITIVE, the triangles are points each classified as NEUTRAL, and the depicted diamonds each are classified as NEGATIVE.

To implement k-NN pattern classification, performance classifier 250 determines a position of an input point 280 within feature space 274. Input point 280 represents the combination of program element operation metrics and reference element activity metrics contained within a given input cross-domain record received by performance classifier 250 from cross-domain synthesizer 248. For k-NN pattern classification, the relative spacing between and among the training points and input point 280 may be computed as Euclidean distances. In this manner, performance classifier 212 computes a relative positioning of input point 280 among the training points which includes, at least in part, determining a Euclidean distance between the multivariate metric data represented by input point 280 and the multivariate metric data represented by each of the training points.

To further implement k-NN pattern classification, performance classifier 250 partitions the feature space 274 into which the training points are mapped with respect to both the position of input point 280 and an input integer value for k. The partitions are represented in FIG. 2D as circular/radial boundaries centered at input point 280 and having a radius determined by a number of nearest neighbors (specified by k) used for classification. As shown, performance classifier 250 determines a radial distance partition 276 for a value of k=3 in which the closest three “neighbor” training points are included. If performance classifier 250 executes the pattern classification algorithm with a value of k=11, the radial distance is determined to be radial distance partition 278. For k=3, performance classifier 250 classifies input point 280 as being or corresponding to the POSITIVE classification since a majority (two of the three) training points within partition 276 are classified as POSITIVE. Similarly, for k=11, performance classifier 250 classifies input point 280 as being or corresponding to the NEUTRAL classification based on determining that a largest plurality (five of eleven) training points within partition 278 are classified as NEUTRAL. Having classified the program elements in one or more cross-domain records, performance classifier 250 records the classification(s) such as by including classification ID entries in each of multiple program element usability performance classification records 252.

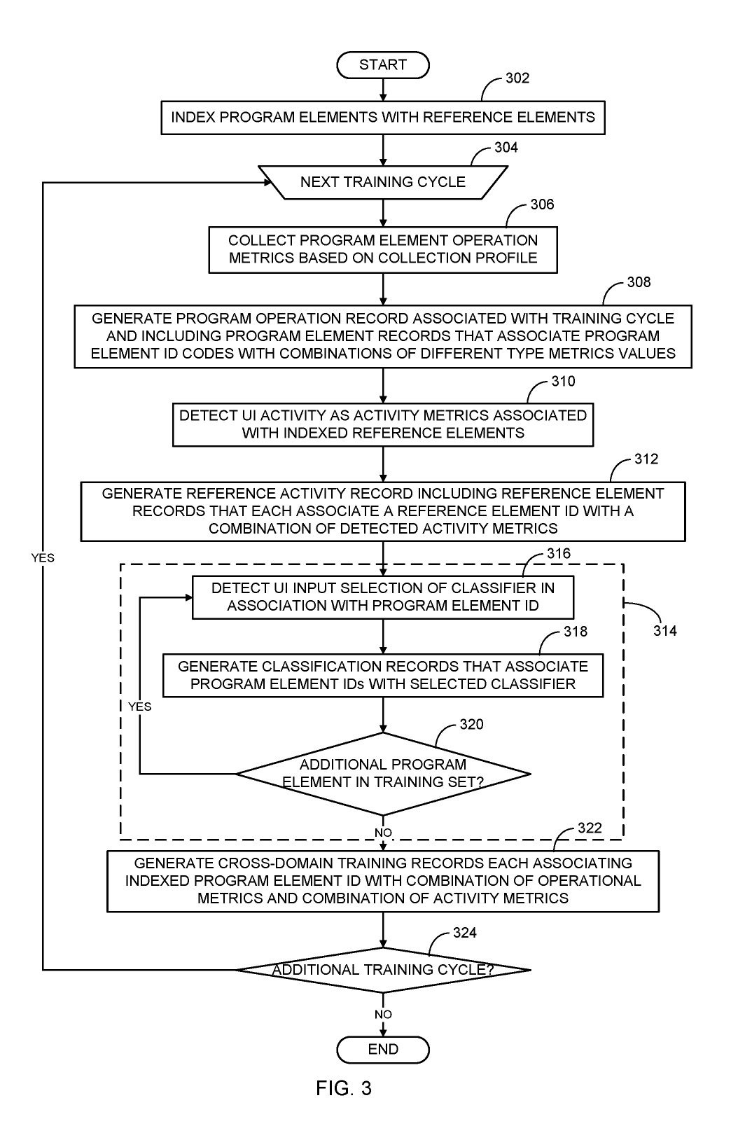

FIG. 3 is a flow diagram illustrating operations and functions for configuring a usability performance classifier in accordance with some embodiments. The operations and functions depicted in FIG. 3 may be performed by one or more of the systems and components depicted and described in FIGS. 1, 2A, 2B, 2C, and 2D. The process begins as shown at block 302 with a training record generator associating program elements of a program with reference elements of a reference document that describes the program. For example, the training record generator may perform a keyword comparison to identify sections, subsection, objects, figures and other UI accessible features of the reference document that are correlated to particular elements of the program. The training record generator may implement the association in a unidirectional or bidirectional manner such as by generating records that each associate a program element field containing a program element ID with one or more reference element fields that containing one or more reference element IDs.

A next training cycle begins as shown at block 304 with a program agent and components of a training data generator collecting operations metrics for program elements based on a collection profile (block 306). Training data generator 108 may comprise performance monitoring elements as well as local client monitor elements including a program agent such as agent 122. At block 308, the program agent and training data generator generate program operation records such as those depicted in FIGS. 1 and 2A. In association with the detecting and recording of the program element operation metrics during a current training cycle, a reference agent detects UI activity as one of a set of specified UI activity types in association with one or more of the associated reference elements (block 310). At block 312, the reference agent in conjunction with the training data generator generate a reference element activity record that includes interaction based event activity associated with one or more of the associated reference elements. The reference agent may generate the reference element activity record to include multiple sub-records that each associate a reference element ID with a combination of detected activity metrics having different types.

The process continues as shown at superblock 314 with the program agent generating program element classification records such as records 232 depicted in FIG. 2A. The program element classification record sub-process begins at block 316 with the program agent in conjunction with UI components of the program detecting UI selection of a classifier, such as a text string classifier, in association with each of one or more of the program elements. At block 318, the program agent generates one or more classification records that associate the program element IDs with the respective classifiers that were selected or otherwise input via the UI in association with the corresponding program elements. If an addition program element remains to be classified as determined at block 320 control returns to block 316.

When all program element classification records are generated, control passes to block 322 with the training record generator generating cross-domain training records such as record 270 in FIG. 2C. The training record generator maps the operation metrics within the program operation records and the reference element activity metrics within the document activity record(s) to program element IDs using the associations determined and recorded at block 302. In response to determining that additional training records are to be generated, control passes back to block 304. Otherwise, the training process end.

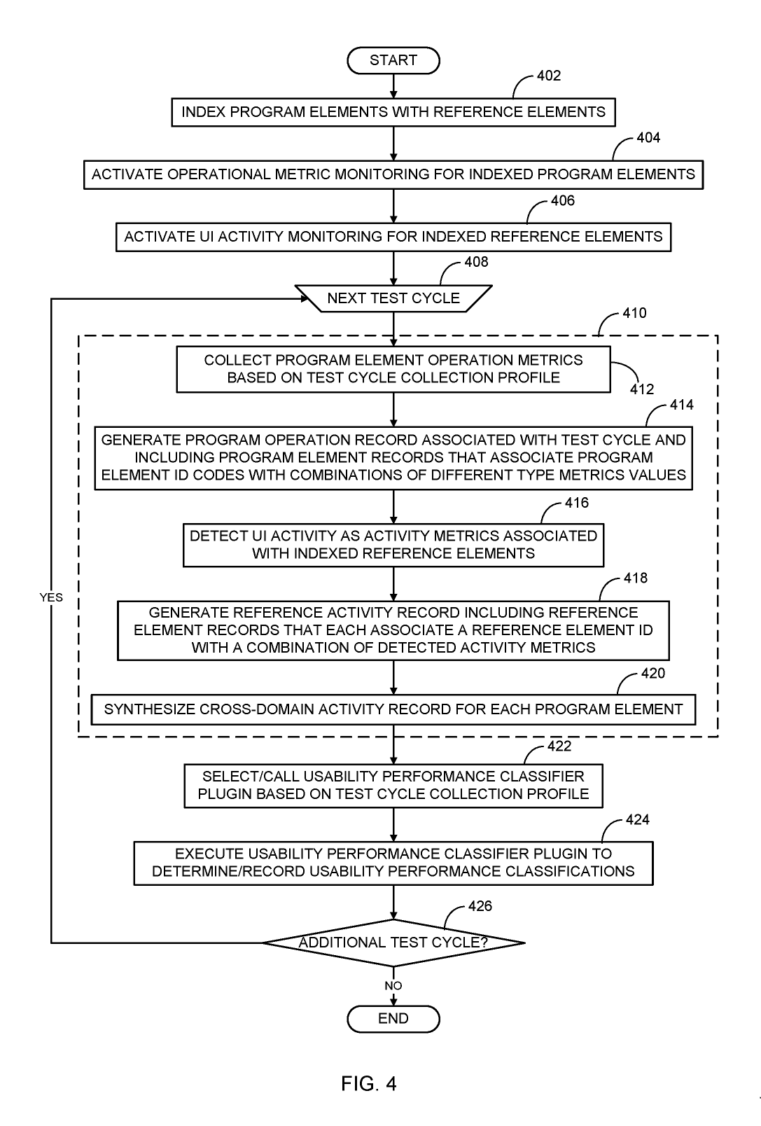

FIG. 4 is a flow diagram depicting operations and functions performed as part of program usability performance classification in accordance with some embodiments. The operations and functions depicted in FIG. 4 may be performed by one or more of the systems and components depicted and described in FIGS. 1, 2A, 2B, 2C, 2D, and 3. The process begins as shown at block 402 with a training record generator associating program elements of a program with reference elements of a reference document that describes the program. In some embodiments, the associating may comprise recording each program element ID in referenced association with one or more reference elements resulting in generation of a association record such as association record 230 in FIG. 2B. At block 404, performance monitoring components including program agents are configured to monitor operation metrics for the associated program elements. At block 406, reference agents are configured to monitor interaction based event activity associated with the associated reference elements.

A next operation test cycle begins as shown at block 408. The test cycle may be requested by a client node that includes a performance test system such as performance test system 242 in FIG. 2A. The test cycle begins with a sequence of operations for generating cross-domain activity patterns (superblock 410). Cross-domain activity pattern generation begins at block 412, with performance monitoring components including program agents commence monitoring the associated program elements based on a collection profile for the current test cycle. The program agents may be configured to detect and record and/or communicate operational metric values for a combination of metric types for each of the program elements. At block 414, the program agent generates a program operation record that is associated with the test cycle (e.g., test cycle ID recorded in operation record metadata) and that includes program element records. In some embodiments, the test cycle may be a performance test cycle or other program performance test cycle. The program operation record includes program element records that each associate a program element ID with a combination of operation metric values that may be cumulative values generated over the course of the operation cycle.

At block 416, a reference agent detects and records interaction based events to one or more of the associated reference elements. In some embodiment, the reference agent generates a document activity record, which similar to the corresponding program operation for the same cycle, is associated with the current test cycle (block 418). The document activity record includes reference element records that each associate a reference element ID with a set of reference activity metric values corresponding to a combination of different reference activity metric types. The cross-domain activity pattern generation cycle concludes at block 420 with a cross-domain synthesizer generating cross-domain input records that each associate a program element ID with the operation metrics and reference activity metrics that were recorded for the program element and the reference elements associated with the program element.

The cross-domain input records form patterns that are received, detected, and processed by a usability performance classifier that is selected based on the collection profile for the current test cycle (block 422). The usability performance classifier is executed and processes the input records to determine and record individual performance classifications for each of the program elements corresponding to the program element IDs. Control passes from block 426 back to block 408 if additional usability tests are scheduled.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

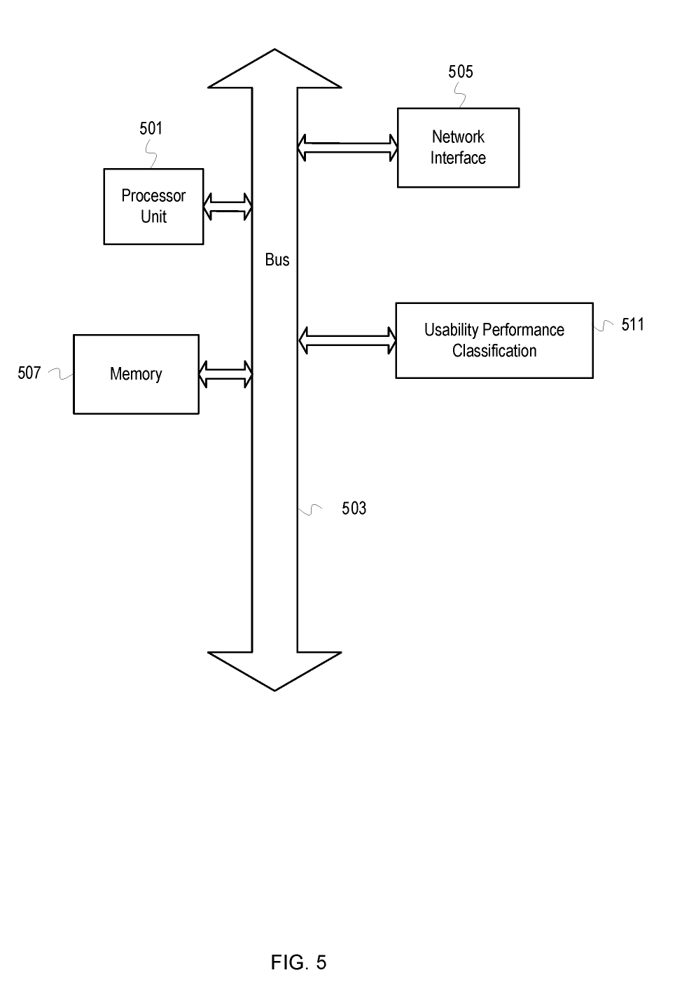

FIG. 5 depicts an example computer system for classifying program performance based on reference object interaction in accordance with some embodiments. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes a usability performance classification sub-system 511 such as may incorporate the systems, devices, and components depicted and described with reference to FIGS. 1-4. The usability performance classification sub-system 511 provides program structures for generating training data to generate performance classification plugins/extensions as depicted and described with reference to FIGS. 1-4. To this end, the usability performance classification sub-system 511 may incorporate and/or utilize some or all of the system, devices, components, and data structures described in FIGS. 1-4.

Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for implementing data collection workflow extensions as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
associating program elements of a program with reference elements of a document that relates to the program;
recording a first set of interaction based events detected by a user interface in association with the document including recording each of the first set of interaction based events in association with a respective one or more of the reference elements;
detecting one or more patterns formed by the recorded set of interaction based events; and
determining performance classifications for one or more of the program elements based on the one or more patterns.

2. The method of claim 1, wherein said determining performance classifications for the one or more of the program elements comprises executing a performance classifier to generate a performance classification for one or more of the program elements based on the one or more patterns.

3. The method of claim 1, further comprising:
collecting operation data for one or more of the program elements; and
generating the one or more patterns including recording the operation data for the one or more of the program elements in association with at least a portion of the first set of interaction based events based on the associations of the program elements with the reference elements.

4. The method of claim 1, wherein said recording a first set of interaction based events includes, for each interaction based event detected in association with one of the reference elements, recording an activity metric value in association with the reference element and an activity metric type.

5. The method of claim 4, wherein said recording a first set of interaction based events includes, for the first set of interaction based events detected during a program operation cycle:
detecting each of the first set of interaction based events as a respective activity metric type; and
recording each of the first set of interaction based events as an activity metric value corresponding to the detected activity metric type and in association with the program operation cycle.

6. The method of claim 5, wherein said recording the first set of interaction based events comprises generating the one or more patterns including generating a document activity record that is associated with the program operation cycle and that includes one or more reference element records corresponding to respective ones of the reference elements in association with which one or more of the interaction based events are detected, wherein each of the reference element records associates a reference element identifier (ID) with activity metric values corresponding to a combination of activity metric types.

7. The method of claim 6, further comprising:
during the program operation cycle, collecting operation data for each of one or more of the program elements;
generating a program operation record associated with the program operation cycle and that associates each of one or more program element IDs of the one or more program elements with the operation data; and
wherein said generating the one or more patterns includes generating cross-domain activity records associated with the program operation cycle and that each associate a program element ID with,
operation data collected for the program element corresponding to the program element ID; and
activity metric values for reference elements associated with the program element corresponding to the program element ID.

8. The method of claim 1, further comprising:
generating one or more program element classification records associated with a program operation cycle and that each associate a program element ID with a program element performance classification;
generating one or more training records each including program element records that each associate a program element ID with,
activity metric values each corresponding to a respective one of a combination of activity metric types; and
one or more of the program element performance classifications; and
executing a trainer that processes the training records to configure pattern-recognition code of the performance classifier.

9. The method of claim 8, wherein each of the program element records associates a program element ID with a combination of activity metric values detected for each of the reference elements.

10. One or more non-transitory machine-readable media comprising program code for classifying program performance, the program code to:
associate program elements of a program with reference elements of a document that relates to the program;
record a first set of interaction based events detected by a user interface in association with the document including recording each of the first set of interaction based events in association with a respective one or more of the reference elements;
detect one or more patterns formed by the recorded set of interaction based events; and
determine performance classifications for one or more of the program elements based on the one or more patterns.

11. The machine-readable media of claim 10, wherein the program code to determine performance classifications for the one or more of the program elements comprises program code to execute a performance classifier to generate a performance classification for one or more of the program elements based on the one or more patterns.

12. The machine-readable media of claim 10, wherein the program code further includes program code to:
collect operation data for one or more of the program elements; and
generate the one or more patterns including recording the operation data for the one or more of the program elements in association with at least a portion of the first set of interaction based events based on the associations of the program elements with the reference elements.

13. The machine-readable media of claim 10, wherein the program code to record a first set of interaction based events includes program code to,
for each interaction based event detected in association with one of the reference elements, record an activity metric value in association with the reference element and an activity metric type; and
for the first set of interaction based events detected during a program operation cycle:
detect each of the first set of interaction based events as a respective activity metric type; and
record each of the first set of interaction based events as an activity metric value corresponding to the detected activity metric type and in association with the program operation cycle.

14. The machine-readable media of claim 13, wherein the program code to record the first set of interaction based events comprises program code to generate the one or more patterns including generating a document activity record that is associated with the program operation cycle and that includes one or more reference element records corresponding to respective ones of the reference elements in association with which one or more of the interaction based events are detected, wherein each of the reference element records associates a reference element identifier (ID) with activity metric values corresponding to a combination of activity metric types.

15. The machine-readable media of claim 14, wherein the program code further includes program code to:
during the program operation cycle, collect operation data for each of one or more of the program elements;
generate a program operation record associated with the program operation cycle and that associates each of one or more program element IDs of the one or more program elements with the operation data; and
wherein the program code to generate the one or more patterns includes program code to generate cross-domain activity records associated with the program operation cycle and that each associate a program element ID with,
operation data collected for the program element corresponding to the program element ID; and
activity metric values for reference elements associated with the program element corresponding to the program element ID.

16. An apparatus comprising:
a processor; and
a machine-readable medium having program code executable by the processor to cause the apparatus to,
associate program elements of a program with reference elements of a document that relates to the program;
record a first set of interaction based events detected by a user interface in association with the document including recording each of the first set of interaction based events in association with a respective one or more of the reference elements;
detect one or more patterns formed by the recorded set of interaction based events; and
determine performance classifications for one or more of the program elements based on the one or more patterns.

17. The apparatus of claim 16, wherein the program code to determine performance classifications for the one or more of the program elements comprises program code to execute a performance classifier to generate a performance classification for one or more of the program elements based on the one or more patterns.

18. The apparatus of claim 16, wherein the program code to record a first set of interaction based events includes program code to,
for each interaction based event detected in association with one of the reference elements, record an activity metric value in association with the reference element and an activity metric type; and
for the first set of interaction based events detected during a program operation cycle:
detect each of the first set of interaction based events as a respective activity metric type; and
record each of the first set of interaction based events as an activity metric value corresponding to the detected activity metric type and in association with the program operation cycle.

19. The apparatus of claim 18, wherein the program code to record the first set of interaction based events comprises program code to generate the one or more patterns including generating a document activity record that is associated with the program operation cycle and that includes one or more reference element records corresponding to respective ones of the reference elements in association with which one or more of the interaction based events are detected, wherein each of the reference element records associates a reference element identifier (ID) with activity metric values corresponding to a combination of activity metric types.

20. The apparatus of claim 19, wherein the program code further includes program code to:
during the program operation cycle, collect operation data for each of one or more of the program elements;
generate a program operation record associated with the program operation cycle and that associates each of one or more program element IDs of the one or more program elements with the operation data; and
wherein the program code to generate the one or more patterns includes program code to generate cross-domain activity records associated with the program operation cycle and that each associate a program element ID with,
operation data collected for the program element corresponding to the program element ID; and
activity metric values for reference elements associated with the program element corresponding to the program element ID.
